(19) United States
(12) Patent Application Publication
(10) Pub. No.: US 2020/0363337 A1
(43) Pub. Date: Nov. 19, 2020

(54) LOW-FLUORESCENCE-PHOTOBLEACHING CONFOCAL IMAGING METHOD AND SYSTEM

(71) Applicants: SUZHOU INSTITUTE OF BIOMEDICAL ENGINEERING AND TECHNOLOGY, CHINESE ACADEMY OF SCIENCES, SUZHOU (CN); SUZHOU GUOKE MEDICAL TECHNOLOGY DEVELOPMENT (GROUP) CO., LTD., SUZHOU (CN)

(72) Inventors: Yuguo Tang, Suzhou (CN); Yunhai Zhang, Suzhou (CN); Yiwen Xu, Suzhou (CN); Yun Xiao, Suzhou (CN); Haomin Yang, Suzhou (CN)

(21) Appl. No.: 16/985,252

(22) Filed: Aug. 5, 2020

Related U.S. Application Data
(63) Continuation of application No. PCT/CN2018/117620, filed on Nov. 27, 2018.

(30) Foreign Application Priority Data
Mar. 21, 2018 (CN) 201810234026.0

(51) Int. Cl. G01N 21/64; G02B 21/00

(52) U.S. Cl. CPC G01N 21/6458; G02B 21/0084; G02B 21/0076; G01N 21/6408

(57) ABSTRACT

Disclosed are a low-fluorescence-photobleaching confocal imaging method and system. A confocal image is first selected as a reference image, and a threshold is set based on pixel values of the reference image. Then the density of fluorescent molecules in a pixel is determined based on a result of comparison of a real-time fluorescence intensity feedback and the threshold. Finally, an illumination time for the pixel is controlled based on the density of fluorescent molecules in the pixel to obtain a low-fluorescence-photobleaching confocal imaging image. The low-fluorescence-photobleaching confocal imaging method and system provided herein control the illumination time for each object-side pixel to make more efficient use of fluorescence information and reduce fluorescence photobleaching without sacrificing image quality, and so can be applied to a variety of biological samples. Further provided is a low-fluorescence-photobleaching confocal imaging system.

### CROSS-REFERENCE TO RELATED APPLICATIONS

This application is a continuation of co-pending International Patent Application Number PCT/CN2018/117620, filed on Nov. 27, 2018, which claims the priority and benefit of Chinese patent application No. 201810234026.0 filed on Mar. 21, 2018 with China National Intellectual Property Administration, the entire contents of which are incorporated herein by reference in their entireties.

### TECHNICAL FIELD

This disclosure relates to the technical field of confocal microscopy, and more particularly relates to a low-fluorescence-photobleaching confocal imaging method and system.

### BACKGROUND

The three major factors of fluorescence photobleaching are fluorescent molecules, chemical environment, and light dose. The photobleaching reduction technique also mainly starts from these three aspects. In these three aspects, the use of special fluorescent dyes such as quantum dots, or changing the chemical environment of fluorescent molecules such as the addition of anti-photobleaching agents, however, are not suitable for ordinary biological samples. In contrast, the method of improving the imaging technology to reduce the light dose is more fitting for ordinary biological samples.

Currently, confocal microscopy imaging typically uses high numerical aperture objective lenses for focusing and imaging, and the resulting high-power-density focused light spot is likely to cause fluorescence photobleaching of the sample. In order to avoid fluorescence photobleaching, one can simply reduce the optical power density, or reduce the illumination time to reduce the light dose, so as to alleviate the problem of fluorescence photobleaching. These methods, however, will reduce the effective fluorescent signals, resulting in loss of detail in the image and a reduction in the signal-to-noise ratio.

### SUMMARY

In view of this, there is a need to provide an imaging technique suitable for low-fluorescence-photobleaching confocal imaging method and imaging system that can control the light dose to reduce photobleaching while not affecting the image quality, thereby overcoming the defects in the related art.

To achieve the above object, the following technical solutions are adopted by this disclosure.

There is provided a low-fluorescence-photobleaching confocal imaging method, including the following operations:

selecting a confocal image as a reference image, and setting a threshold based on the pixel values of the reference image;

determining the density of fluorescent molecules in a pixel based on a result of comparison between a real-time fluorescence intensity feedback and the threshold, and controlling the illumination time for the pixel based on the density of fluorescent molecules in the pixel, where the feedback refers to the pixel value read at a certain moment during the scanning process of a certain pixel; and obtaining a low-fluorescence-photobleaching confocal imaging image.

In some typical embodiments, the operation of “selecting a confocal image as a reference image, and setting a threshold based on the pixels values of the reference image” may include the following:

$$setting the average value of 5 \% of the maximum pixel values in the reference image \cdot \frac{a decision time}{a pixel dwell time} as a high threshold ; and$$

$$setting the average value of the 5 \% minimum pixel values in the reference image \cdot \frac{a decision time}{a pixel dwell time} + background noise average values as a low threshold ;$$

where the decision time is the time when the feedback is read for the first time, and the pixel dwell time is the time when the center of the optical spot stays at a single object-side pixel, and the feedback refers to the pixel value read at a certain time during the scanning process of a pixel, which is also called a sampled pixel value.

In some typical embodiments, the operation of “determining the density of fluorescent molecules in a pixel based on the threshold, and controlling the illumination time for the pixel based on the density of fluorescent molecules in the pixel” may include the following: start reading feedback and making a judgment since the decision time, where in response to feedback being below the low threshold, turning off the illumination time for the pixel, and in response to the feedback being above the high threshold, turning off the illumination time for the pixel.

In addition, the present disclosure further provides a low-fluorescence-photobleaching confocal imaging system, including a confocal imaging module, an electronic control module, and a host computer module. The confocal imaging module includes a laser, a light intensity adjustment component, a high-speed optical switch, a dichroic mirror, a reflection mirror, a relay lens, a tube lens, an objective lens, a displacement stage, a detector, a pinhole, and a detection lens. The electronic control module is electrically connected to the high-speed optical switch, and the host computer module is electrically connected to the electronic control module.

The confocal imaging module is used to form a reference image. The host computer module sets a threshold based on the pixel values of the reference image. The electronic control module obtains a fluorescence intensity feedback value and compares it with the threshold, and finally controls the turning on and off of the high-speed optical switch based on the result of the comparison, thus realizing the control of the illumination time for the pixel, where the feedback refers to the pixel value read at a certain moment in the scanning process of a certain pixel.

In some typical embodiments, the electronic control module is composed of a central control unit and an optical switch control unit. The central control unit is used to electrically connect to the host computer module. The optical switch control unit is electrically connected to the high-speed optical switch. The central control unit communicates with the host computer module in real time via Ethernet, and is used to receive and analyze a task instruction sent by the host computer and feed back the hardware status to the host computer module. The optical switch control unit is used to output a control waveform in accordance with the instruction of the central control unit to control the turning on of the high-speed optical switch thus controlling the illumination time of pixels in the light path.

In some typical embodiments, the central control unit is further electrically connected to the detector and the displacement stage.

The advantages of the present invention using the above technical solutions are as follows.

In the low-fluorescence-photobleaching confocal imaging method and system provided by the present disclosure, a confocal image is first selected as a reference image, and a threshold is set based on the pixel values of the reference image. Then the density of fluorescent molecules in a pixel is determined based on the real-time fluorescence intensity feedback and the threshold. Finally, the illumination time for the pixel is controlled based on the density of fluorescent molecules in the pixel to obtain a low-fluorescence-photobleaching confocal imaging image. The low-fluorescence-photobleaching confocal imaging method and system provided by the present disclosure control the illumination time for each object-side pixel to make more efficient use of fluorescence information and reduce fluorescence photobleaching without sacrificing image quality, and so can be applied to a variety of biological samples.

### BRIEF DESCRIPTION OF DRAWINGS

To better illustrate the technical solutions according to embodiments of this disclosure or in the prior art, the accompanying drawings required in the description of the embodiments herein or the prior art will now be briefly described. Apparently, the accompanying drawings in the following description show merely some embodiments of this disclosure, and those of ordinary skill in the art will be able to obtain other drawings based on these drawings without making creative efforts, where in the drawings:

FIG. 1 is a flow chart illustrating steps of a low-fluorescence-photobleaching confocal imaging method provided in Embodiment 1 according to the present disclosure.

FIG. 2(a) of FIG. 2 is a schematic diagram illustrating the feedback and judgment process for an extreme sparsity of fluorescent molecules according to Embodiment 1 of the present disclosure.

FIG. 2(b) of FIG. 2 is a schematic diagram illustrating the feedback and judgment process for a high density of fluorescent molecules according to Embodiment 1 of the present disclosure.

FIG. 2(c) of FIG. 2 is a schematic diagram illustrating the feedback and judgment process for a moderate density of fluorescent molecules according to Embodiment 1 of the present disclosure.

FIG. 3 is a schematic diagram illustrating the segmentation of the process of determining a high threshold according to Embodiment 1 of the present disclosure.

FIG. 4(a) is a schematic diagram illustrating the pixel illumination time distribution according to Embodiment 1 of the present disclosure.

FIG. 4(b) is a schematic diagram illustrating the sampling pixel value distribution according to Embodiment 1 of the present disclosure.

FIG. 4(c) shows a CLE-CM restored image provided by Embodiment 1 of the present disclosure.

FIG. 5 is a schematic diagram illustrating the structure of a low-fluorescence-photobleaching confocal imaging system provided in Embodiment 2 according to the present disclosure.

FIG. 6 is a block diagram illustrating the working principle of the electronic control module provided in Embodiment 2 of the present disclosure.

### DETAILED DESCRIPTION

Technical solutions embodied in the embodiments of this disclosure will now be clearly and comprehensively described in connection with the accompanying drawings for these embodiments. Apparently, the described embodiments are merely some but not all embodiments of this disclosure. All other embodiments obtained by persons of ordinary skill in the art based on the embodiments of this disclosure without making creative efforts shall all fall within the protection scope of the present disclosure.

### Embodiment 1

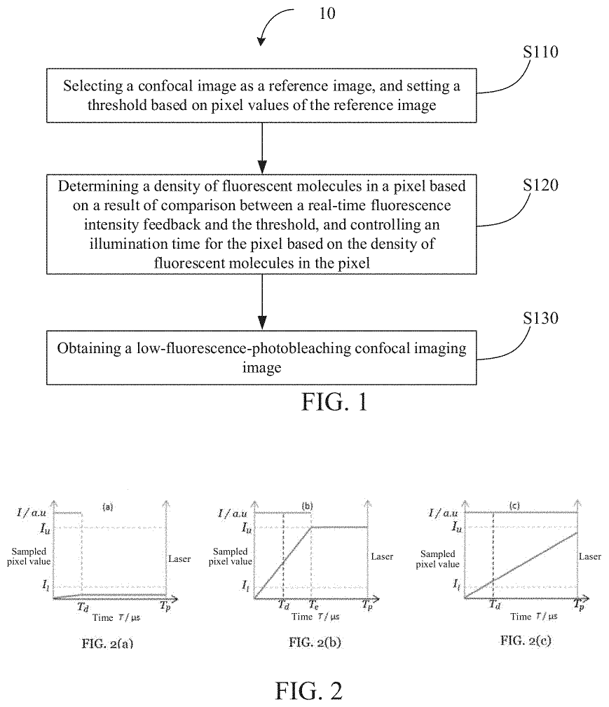

FIG. 1 is a flow chart illustrating steps of a low-fluorescence-photobleaching confocal imaging method 10 provided in Embodiment 1 according to the present disclosure. The method 10 may include the following operations S110, S120, and S130.

In step S110, the method may include selecting a confocal image as a reference image, and setting a threshold based on the pixel values of the reference image.

It is understood that before imaging in the low-fluorescence-photobleaching confocal imaging method (Controllable Light Exposure-Confocal Microscopy, CLE-CM), a standard confocal image may be taken as a reference image and a threshold may be set for this reference image.

In some typical embodiments, the above step S110 may include the following:

$$S 111 \text{:} setting the average value of 5 \% of the maximum pixel values in the reference image \cdot \frac{a decision time}{a pixel dwell time} as a high threshold ; and$$

$$S 112 \text{:} setting the average value of 5 \% of the minimum pixel values in the reference image \cdot \frac{a decision time}{a pixel dwell time} + background noise average value as a low threshold ;$$

In S120, the method may include determining the density of fluorescent molecules in a pixel based on a result of comparison between a real-time fluorescence intensity feedback and the threshold, and controlling the illumination time for the pixel based on the density of fluorescent molecules in the pixel.

In this embodiment, the feedback refers to the pixel value I read at a certain moment during the scanning process of a certain pixel, which is called a sampled pixel value. The time T_{d} when the feedback is read for the first time is called the decision time. The time Tₚ during which the optical spot center stays on a single object-side pixel is called the pixel dwell time. The time Tₑ when the CLE-CM laser is actually turned on is called the actual lighting time of the pixel, and the Iₑ corresponding to Tₑ is called the actual pixel value.

In some typical embodiments, the above operation S120 may include the following S121 and S122.

In S121, the operation may include starting reading feedback and making a judgment since the decision time, where in response to feedback being below the low threshold, turning off the illumination time for the pixel.

It is appreciated that illumination may be kept for a short period of time at the beginning of the scanning process of each pixel. Then the feedback may be read and a judgment made since the decision time. If the feedback does not reach the low threshold, it means that the fluorescent molecules in the pixel are extremely sparse and cannot provide fluorescence information. In this case, the laser would be turned on immediately, namely turning off the illumination time for the pixel as illustrated in FIG. 2(a), which shows a schematic diagram illustrating the feedback and judgment process where the fluorescent molecules are extremely sparse.

In S121, the operation may include in response to the feedback being above the high threshold, turning off the illumination time for the pixel.

It is appreciated that if the feedback reaches a high threshold, it means that the fluorescent molecules in the pixel are very dense and enough fluorescent information has been obtained. In this case, the laser would be turned off immediately namely turning off the illumination time for the pixel, as illustrated in FIG. 2(b), which shows a schematic diagram illustrating the feedback and judgment process where the fluorescent molecules are in a high density. If the sampled pixel value at the end of the pixel dwell time still does not reach the high threshold, it means that the density of fluorescent molecules in the pixel is moderate, and the light dose is not excessive, as illustrated in FIG. 2(c), which shows a schematic illustrating the feedback and judgment process where the fluorescent molecules are in a moderate density.

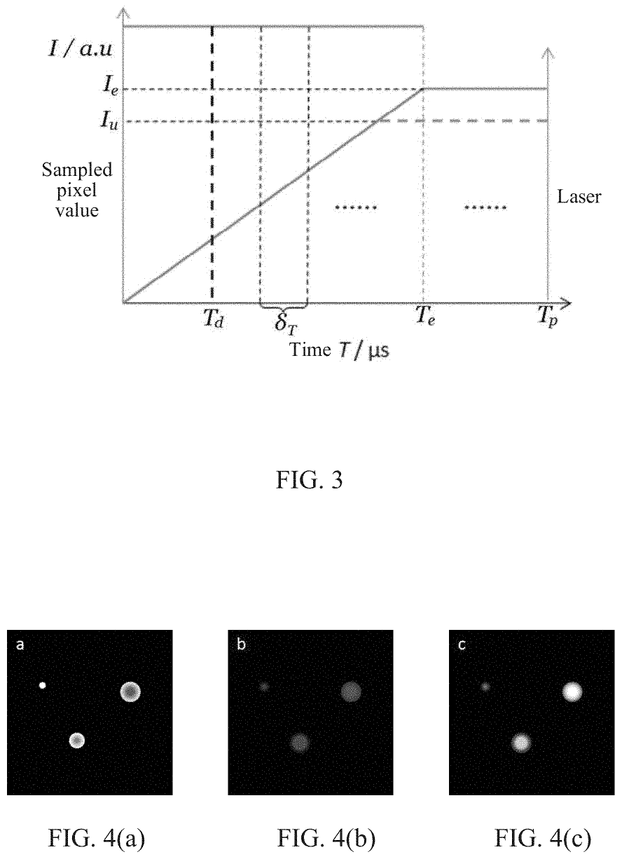

Further, the ideal situation for feedback and judgment is real-time monitoring and feedback, and the laser is turned off at the exact time point when it just reaches the high threshold, but in practice such real-time monitoring is difficult to achieve. So an approximation method is used to divide the pixel dwell time into a number of N segments, as illustrated in FIG. 3, and the feedback is read at the end of each segment, and so the actual pixel illumination time is

$${T}_{e} = {T}_{d} + k {δ}_{T} ( k = 0 , 1 , … , N - 1 , {δ}_{T} = \frac{{T}_{p} - {T}_{d}}{N - 1} ) ,$$

and δ_{T} is the time interval between adjacent judgments. Theoretically, the larger N is, the larger the value range of k is, and the more subtle the change of the pixel illumination time is.

In S130, the method may include obtaining an image through low-fluorescence-photobleaching confocal imaging.

It is understood that after scanning an image in CLE-CM, two sets of data are obtained, one set is the actual illumination time of each pixel, as illustrated in FIG. 4(a), and the other set is the actual pixel value of each pixel, as illustrated in FIG. 4(b).

Because the laser intensity is constant, assuming that the fluorescence is not saturated and the fluorescence intensity is unchanged, then the pixel value would be equal to the product of the fluorescence intensity and the illumination time within the pixel dwell time T_p. Then based on the linear relationship between the two, the CLE-CM image can be recovered as illustrated in FIG. 4(c).

In the low-fluorescence-photobleaching confocal imaging method provided by Embodiment 1 of the present disclosure, a confocal image is first selected as a reference image, and a threshold is set based on the pixel values of the reference image. Then the density of fluorescent molecules in a pixel is determined based on the result of comparison between the real-time fluorescence intensity feedback and the threshold. Finally, the illumination time for the pixel is controlled based on the density of fluorescent molecules in the pixel to obtain a low-fluorescence-photobleaching confocal imaging image. The above method can control the illumination time for each object-side pixel to make more efficient use of fluorescence information and reduce fluorescence photobleaching without sacrificing image quality, and so can be applied to a variety of biological samples.

### Embodiment 2

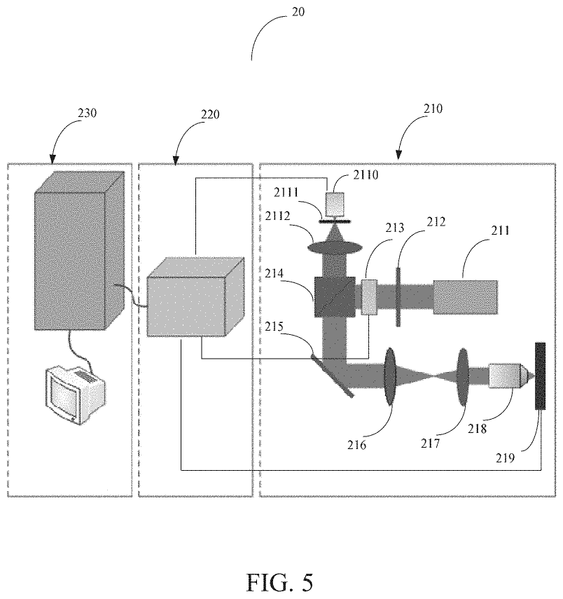

FIG. 5 is a schematic diagram illustrating the structure of a low-fluorescence-photobleaching confocal imaging system 20 provided in Embodiment 2 according to the present disclosure. The system 20 may include a confocal imaging module 210, an electronic control module 220, and a host computer module 230. The confocal imaging module 210 may include a laser 211, a light intensity adjustment component 212, a high-speed optical switch 213, a dichroic mirror 214, a reflection mirror 215, a relay lens 216, a tube lens 217, an objective lens 218, a displacement stage 219, and a detector 2110, a pinhole 2111, and a detection lens 2112. The electronic control module 220 is electrically connected to the high-speed optical switch 213. The host computer module 230 is electrically connected to the electronic control module 220.

It is understood that the confocal imaging module 210 may be used to obtain a confocal image as a reference image. The host computer module 230 may set a threshold based on the pixel values of the reference image, and determine the density of fluorescent molecules in a pixel based on the threshold. The host computer module 230 may further be used to control the operation of the electronic control module based on the density of fluorescent molecules, and the electronic control module 220 may control the turning on and off of the high-speed optical switch 213 to realize the control of the illumination time for the pixels.

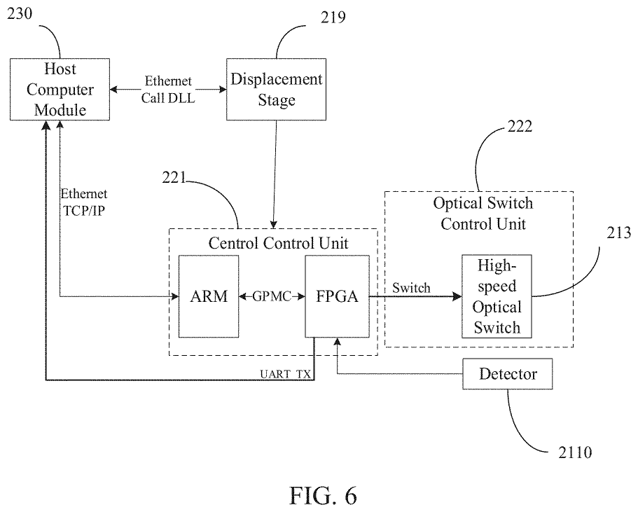

Referring to FIG. 6, the electronic control module 220 is composed of a central control unit 221 and an optical switch control unit 222. The central control unit 221 is used to electrically connect to the host computer module 230. The optical switch control unit 222 is electrically connected to the high-speed optical switch 213.

The central control unit 221 is composed of ARM and FPGA control boards. The central control unit 221 communicates with the host computer module 230 in real time via Ethernet to receive and analyze a task instruction sent by the host computer module 230. Meanwhile, the central control unit 221 can feed back the hardware status to the host computer module 230 to realize effective control of each hardware unit.

The optical switch control unit 222 is responsible for receiving the feedback from the central control unit 221 and comparing it with the threshold and outputting a control waveform based on the result of the comparison. The control waveform controls the high-speed optical switch 213 to be turned on and off, thereby realizing the ON and OFF control of the laser in the optical path.

In some typical embodiments, the central control unit 221 is further electrically connected to the detector 2110 and the displacement stage 219, and can be used to realize the synchronous control of the scanning of the detector 2110 and the displacement stage 219, thereby achieving confocal imaging with controllable light dose.

The low-fluorescence-photobleaching confocal imaging system provided by the present disclosure includes a confocal imaging module 210, an electronic control module 220, and a host computer module 230. The confocal imaging module 210 may be used to obtain a confocal image as a reference image. The host computer module 230 may set a threshold based on the pixel values of the reference image, and determine the density of fluorescent molecules in a pixel based on the threshold. The host computer module 230 may further be used to control the operation of the electronic control module based on the density of fluorescent molecules, and the electronic control module 220 may control the turning on and off of the high-speed optical switch 213 to realize the control of the illumination time for the pixels. Thus, the fluorescent photobleaching during confocal imaging is effectively reduced, which facilitates the application of confocal imaging technique in biological research.

Of course, the low-fluorescence-photobleaching confocal imaging method according to the present disclosure may also have a variety of changes and modifications, and so will not be limited to the specific structures according to the foregoing embodiments. In a word, the scope of protection of the present disclosure shall include those alterations, substitutions, and modifications obvious to those skilled in the art.

What is claimed is:

1. A low-fluorescence-photobleaching confocal imaging method, comprising:
selecting a confocal image as a reference image, and setting a threshold based on pixel values of the reference image;
determining a density of fluorescent molecules in a pixel based on a result of comparison between a real-time fluorescence intensity feedback and the threshold, and controlling an illumination time for the pixel based on the density of fluorescent molecules in the pixel, wherein the feedback refers to the pixel value read at a certain moment during a scanning process of the pixel; and
obtaining a low-fluorescence-photobleaching confocal imaging image.

2. The low-fluorescence-photobleaching confocal imaging method as recited in claim 1, wherein the operation of “selecting a confocal image as a reference image, and setting a threshold based on the pixels values of the reference image” comprises:
$$setting the average value of 5 \% of the maximum pixel values in the reference image times \frac{a decision time}{a pixel dwell time} as a high threshold ; and$$
$$setting an average value of the 5 \% minimum pixel values in the reference image times \frac{a decision time}{a pixel dwell time} plus a background noise average values as a low threshold ;$$
wherein the decision time is the time when the feedback is read for the first time, and the pixel dwell time is the time when the center of an optical spot stays at a single object-side pixel, and the feedback refers to the pixel value read at the certain time during the scanning process of the pixel, which is called a sampled pixel value.

3. The low-fluorescence-photobleaching confocal imaging method as recited in claim 2, wherein the operation of “determining a density of fluorescent molecules in a pixel based on a result of comparison between a real-time fluorescence intensity feedback and the threshold, and controlling an illumination time for the pixel based on the density of fluorescent molecules in the pixel” comprises:
starting reading feedback and making a judgment since the decision time, where in response to the feedback being below the low threshold, turning off the illumination time for the pixel, and in response to the feedback being above the high threshold, turning off the illumination time for the pixel.

4. A low-fluorescence-photobleaching confocal imaging system, comprising a confocal imaging module, an electronic control module, and a host computer module; the confocal imaging module comprises a laser, a light intensity adjustment component, a high-speed optical switch, a dichroic mirror, a reflection mirror, a relay lens, a tube lens, an objective lens, a displacement stage, a detector, a pinhole, and a detection lens; the electronic control module is electrically connected to the high-speed optical switch, and the host computer module is electrically connected to the electronic control module;
wherein the confocal imaging module is configured to form a reference image; the host computer module is configured to set a threshold based on pixel values of the reference image; the electronic control module is configured to obtain a fluorescence intensity feedback value and compare it with the threshold, and control turning on and off of the high-speed optical switch based on a result of the comparison thus realizing control of an illumination time for a pixel, wherein the feedback refers to the pixel value read at a certain moment in the scanning process of the pixel.

5. The low-fluorescence-photobleaching confocal imaging system as recited in claim 4, wherein the electronic control module is comprised of a central control unit and an optical switch control unit; the central control unit is used to electrically connect to the host computer module, the optical switch control unit is electrically connected to the high-speed optical switch; the central control unit is configured to communicate with the host computer module in real time via Ethernet, and is configured to receive and analyze a task instruction sent by the host computer and feed back a hardware status to the host computer module; the optical switch control unit is configured to output a control waveform in accordance with the instruction of the central control unit to control the turning on of the high-speed optical switch thus controlling the illumination time of pixels in a light path.

6. The low-fluorescence-photobleaching confocal imaging system as recited in claim 5, wherein the central control unit is further electrically connected to the detector and the displacement stage.
